(19) United States
(12) Patent Application Publication
(10) Pub. No.: US 2006/0012489 A1
(43) Pub. Date: Jan. 19, 2006

(54) Appliance control apparatus and electrical appliance

(75) Inventors: Toshimi Yokota, Hitachiohta (JP); Hideaki Suzuki, Hitachi (JP); Shoji Yoshida, Hitachi (JP); Satoru Funaki, Hitachi (JP); Masahiko Saito, Mito (JP); Yasuyuki Kojima, Hitachi (JP); Akihiko Kanouda, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/063,854

(22) Filed: Feb. 23, 2005

(30) Foreign Application Priority Data
Jul. 17, 2004 (JP) 2004-200009

(51) Int. Cl. H04Q 1/00; G08C 19/00

(52) U.S. Cl. 340/825.72; 340/5.74

(57) ABSTRACT

Power is taken out from radio waves through an antenna and a power receiving unit. A signal receiver, a comparator, and an ID signal holder are operated with the taken-out power to compare an ID contained in a received signal with an ID read out from the ID signal holder. When both the ID's are matched with each other, a switch for a main power source is turned on. In trying to remotely operate household electrical appliances by utilizing the Internet that has become increasingly popular, standby power is consumed if the electrical appliances are kept in a standby state at all times. Since power is taken out from radio waves, the invention is able to cut the standby power in an environment where the radio waves are transferred via radio communication that is expected to be more and more prevalent in future.

### CLAIM OF PRIORITY

The present application claims priority from Japanese application serial no. 2004-200009, filed on Jul. 17, 2004, the content of which is hereby incorporated by reference into this application.

### BACKGROUND OF THE INVENTION

1. Field of the Invention

The present invention relates to an appliance control apparatus and an electrical appliance for use in homes.

2. Description of the Related Art

In trying to remotely operate household electrical appliances by utilizing the Internet that has become increasingly popular, standby power is consumed if the household electrical appliances are kept in a standby state at all times. To solve such a problem by utilizing radio communication that seems to be more and more prevalent in future, JP,A 2001-197573 (hereinafter referred to as Patent Reference 1) discloses a technique of taking out power from radio waves, turning on a secondary cell Vdd, comparing a received signal with an ID signal, and turning on a main power source Vc if both the signals are matched with each other.

### SUMMARY OF THE INVENTION

The technique disclosed in Patent Reference 1 has a problem that, in an environment where there are a plurality of appliances, such as an illuminator, a TV set, an air conditioner and a camera, and radio signals are transferred via them, the secondary cells Vdd are always required and the standby power is increased.

A first object of the present invention is to, in an environment where there are a plurality of appliances, such as an illuminator, a TV set, an air conditioner and a camera, and radio signals are transferred via them, cut standby power by taking out power from radio waves and effectively utilizing the taken-out power.

A second object is to additionally supply power when the power taken out from the radio waves is not sufficient in some environment.

A third object is to suppress power consumption resulting from the operation during a standby state.

To achieve the first object, the present invention provides an appliance control apparatus comprising an antenna for receiving radio waves; a power receiving unit for taking out power from the radio waves received by the antenna; a capacitor for accumulating the power taken out by the power receiving unit; a signal receiving unit operated with the power accumulated in the capacitor and receiving a signal from the radio waves received by the antenna; an ID signal holding for holding an ID signal; a switch for selectively connecting an appliance and a power source; and a comparing unit for receiving the signal from the signal receiving unit, comparing a target appliance ID contained in the received signal with an ID read out from the ID signal holding unit when the received signal is a predetermined signal, and turning on the switch when both the ID's are matched with each other.

To achieve the second object, the present invention provides an appliance control apparatus comprising an antenna for receiving radio waves; a capacitor for accumulating the power taken out by the power receiving unit; a signal receiving unit operated with the power accumulated in the capacitor and receiving a signal from the radio waves received by the antenna; an ID signal holding for holding an ID signal; a switch for controlling whether power is to be received from a main power source; a comparing unit for receiving the signal from the signal receiving unit, comparing a target appliance ID contained in the received signal with an ID read out from the ID signal holding unit when the received signal is a predetermined signal, and turning on the switch when both the ID's are matched with each other; and a charge control unit for charging power in the capacitor from the main power source when the power accumulated in the capacitor is not sufficient.

To achieve the third object, the present invention provides an appliance control apparatus comprising an antenna for receiving radio waves; a capacitor for accumulating the power taken out by the power receiving unit; a signal receiving unit operated with the power accumulated in the capacitor and receiving a signal from the radio waves received by the antenna; an ID signal holding for holding an ID signal; a switch for controlling whether power is to be received from a main power source; a comparing unit for receiving the signal from the signal receiving unit, comparing a target appliance ID contained in the received signal with an ID read out from the ID signal holding unit when the received signal is a predetermined signal, and turning on the switch when both the ID's are matched with each other; and a timer unit for controlling a time during which the signal receiving unit is operated.

Other features of the present invention will be described in the following description.

According to the present invention, it is possible to reduce standby power consumed by the appliance control unit and electrical appliances, and to realize energy saving.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates an environment in which household electrical appliances are installed;

FIG. 2 is a block diagram of a first embodiment of the present invention;

FIG. 3 is a diagram of a circuit for transmitting and receiving power via millimeter waves;

FIG. 4 is a diagram of a circuit for transmitting and receiving power via microwaves;

FIG. 5 is a block diagram of an antenna unit suitable for directional radio communication;

FIG. 6 is a sequence chart showing a communication procedure for linked operation;

FIG. 7 illustrates an environment in which an electrical appliance is installed;

FIG. 8 is a sequence chart showing a communication procedure for linked operation;

FIG. 9 is a block diagram of a second embodiment of the present invention;

FIG. 10 is a time chart showing the relationship between the start and end of charge and voltage;

FIG. 11 is a flowchart showing the operation of the second embodiment;

FIG. 12 is a block diagram of a third embodiment of the present invention;

FIG. 13 is a time chart for explaining time periods set by timers; and

FIG. 14 is a flowchart showing the operation of the third embodiment.

### DESCRIPTION OF THE PREFERRED EMBODIMENTS

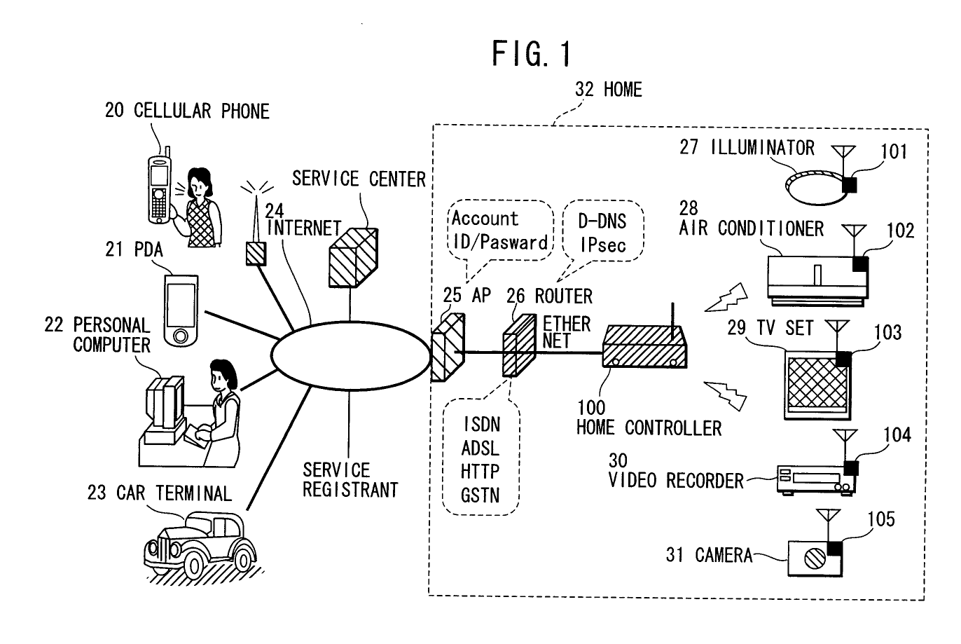

One embodiment of the present invention will be described in detail below with reference to FIGS. 1-14. This embodiment is concerned with a technique for cutting standby power in communications performed to monitor and control household electrical appliances, or to monitor and control various kinds of equipment used in buildings and homes, such as air conditioners, security apparatus, illumination units and elevators, or to monitor and control apparatus and equipment used in infrastructures, such as power, gas and water supply facilities.

FIG. 1 illustrates an environment for use of household electrical appliances to which radio modules 101-105 are applied according to this embodiment. A user makes connection to the Internet 24 from a cellular phone 20, a PDA 21, a personal computer 22, a car terminal 23 or the like with a browser installed therein. In a home 32, a home controller 100 is connected to the Internet 24 via an access point (AP) 25, a router 26 or the like. The home controller 100 serves as a radio access point for various electrical appliances, such as an illuminator 27, a TV set 29, an air conditioner 28, a video cassette recorder 30 and a camera 31, and it also has the function of supplying power to the appliances in a standby state. With such a system, the user can turn on and off the illuminator 27, the air conditioner 28, etc. using the browser, while each appliance consumes no power until it receives a turning-on command. This is similarly applied to the case where linked operation is performed between the appliances without resorting to direct operation by the user. For example, in the case of the appliance being operated in combination with the cellular phone 20 or the car terminal 23, the illuminator can be turned on and a door or a gate can be unlocked and locked just when the user comes close to, e.g., the home, by adding the GPS function to confirm the current position of the user and commanding, from a service center, the home controller 100 to output a control signal when the cellular phone or the car terminal comes within a certain distance from a position designated by the user. Until receiving the control signal, the appliance consumes no power.

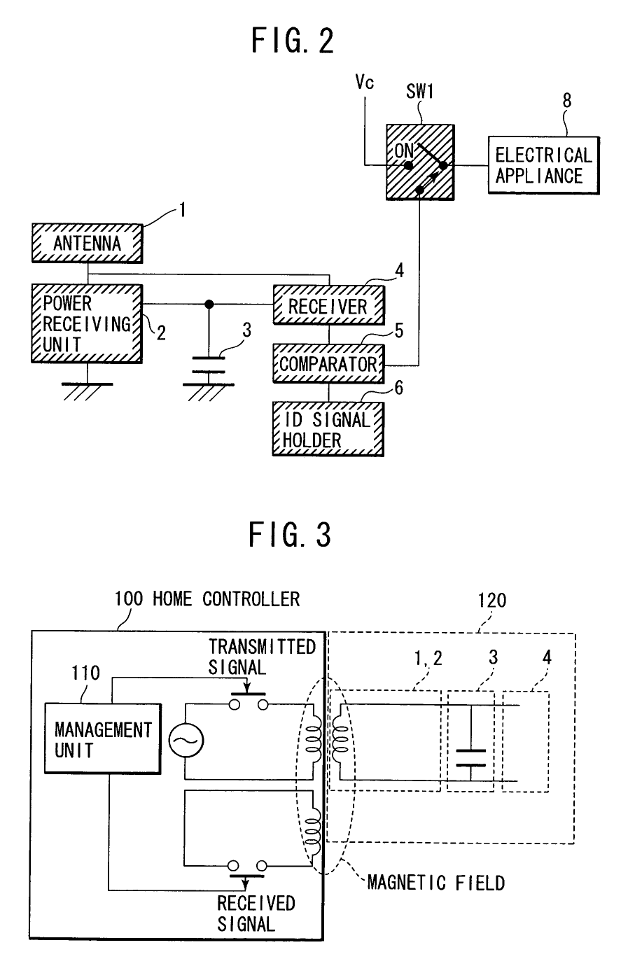

FIG. 2 is a block diagram of one example of the radio modules 101-105 shown in FIG. 1. An antenna 1 receives radio waves and transfers the received radio waves to a power receiving unit 2 and a receiver 4. The power receiving unit 2 performs impedance matching of the received radio waves, takes out power from the radio waves, and accumulates the power in a capacitor (or a secondary cell) 3. The receiver 4, a comparator 5, and an ID signal holder 6 operate as follows with the power accumulated in the capacitor 3. The receiver 4 receives the radio waves, as a radio signal, from the antenna 1 and transfers the radio signal to the comparator 5. The comparator 5 analyzes the radio signal received from the receiver 4 and acquires an ID contained in the radio signal if the radio signal commands change from a standby state to an operative state. Also, the comparator 5 acquires, from the ID signal holder 6, an ID assigned to an electrical appliance 8 and compares both the ID's. If both the ID's are matched with each other, a main power source switch SW1 is turned on. Thus, the electrical appliance 8 is supplied with power and is changed from the standby state to the operative state.

The main power source switch SW1 is held in an off-state during standby and is turned on by the comparator 5. Also, the main power source switch SW1 in an on-state can be turned off by one of two methods, i.e., by turning off the switch SW1 from the electrical appliance 8, or by turning off the switch SW1 from the comparator 5 after identifying not only the ID signal, but also an on/off signal in the comparator 5. When the main power source switch SW1 is in the on-state, the electrical appliance 8 is operated by performing radio communication via the home controller 100 and receiving various control signals. Therefore, the main power source switch SW1 is preferably changed to the off-state by turning off it from the electrical appliance 8 when the priority order requires to be compared with other operations, or by turning off it from the comparator 5 if otherwise.

The components other than the electrical appliance 8 are constructed in the form of one module that is built in the electrical appliance 8 as one part thereof. The ID assigned to the electrical appliance 8 is preferably given as an ID address. The ID signal holder 6 can hold the ID that is copied in advance from an ID holder (not shown) used in the operative state, or it can be prepared in common with the ID holder used in the operative state.

The electrical appliance 8 in the on-state performs radio communication via the home controller 100, and it employs the antenna 1 and the receiver 4 during the radio communication as well. However, preferably, another set of antenna and receiver separately operated with the main power source is provided so that a receiving system is optimized for each of the power receiving function and the communication function.

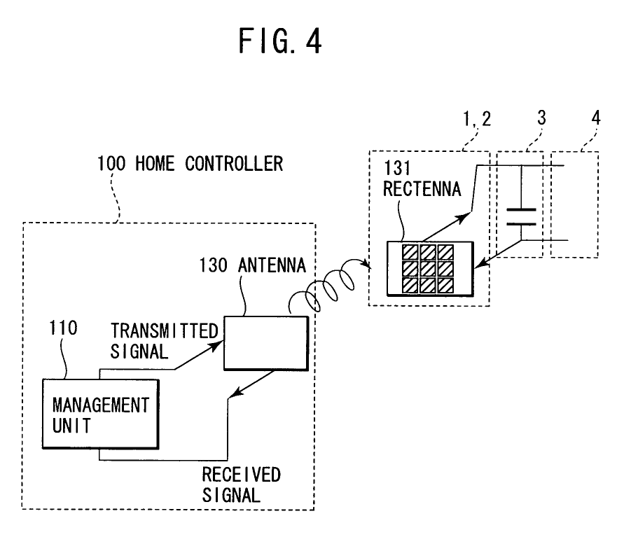

For more detailed explanation of the antenna 1 and the power receiving unit 2 both shown in FIG. 2 and the home controller 100 on the power transmitting side, a power transmitting unit and a power receiving unit will be described below with reference to FIGS. 3 and 4. While as power transmitting methods there are known an electrostatic coupling method, an electromagnetic coupling method, an electromagnetic induction method, and a microwave method, it is required to change the method depending on the wavelength of radio waves used.

The advantage of this embodiment is described here in comparison with Patent Reference 1. In the known related art, the secondary cell Vdd is turned on at once upon receiving the “signal=radio waves” and the ID comparison is performed with power from the secondary cell Vdd. Accordingly, the secondary cell Vdd is turned on even when the signal is not destined for the relevant appliance. Stated another way, in a situation where radio waves are frequently transferred via a plurality of appliances, the secondary cell Vdd is kept turned on at all times, and the effect of power saving is not so expected. In contrast, in this embodiment, the ID comparison is performed using the “signal=radio waves=power” and the main power source Vc is turned on if both the ID's are matched with each other. Therefore, the effect of power saving is realized because the power taken out from the radio waves is accumulated and the main power source Vc is not turned on unless the signal is destined for the relevant appliance.

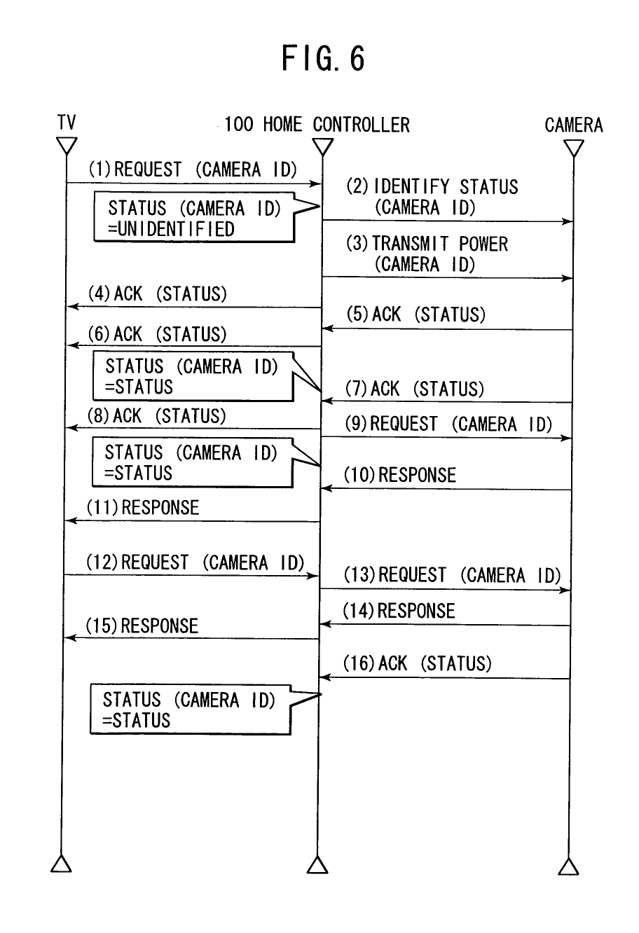

FIG. 3 shows one example of a circuit suitable for the case utilizing electromagnetic waves in a band of millimeter waves, specifically at 13.56 MHz in a band of short waves. In this circuit, radio communication is performed with a voltage induced between a coil in the home controller 100 on the power transmitting side and a coil in the radio module on the power receiving side. The intensity of the induced voltage depends on the intensity of magnetic flux received by the antenna and the number of windings of the coil on the power receiving side. This circuit is featured in that it can be comparatively easily used even in bad environments, such as factories and roads. A management unit 110 transmits radio waves containing the ID signal representing the other side to be communicated with and receives an ACK signal from the power receiving side. Details of the operation will be described later with reference to FIGS. 6 and 7.

FIG. 4 shows one example of a circuit suitable for the case utilizing radio waves in a band of microwaves. As compared with the circuit shown FIG. 3, this circuit is featured in that communication can be more easily realized over a long distance. For the purpose of increasing efficiency, it is preferable to employ, on the power receiving side, a rectifier-equipped antenna (so-called Rectenna) 131 in the form of an array comprising a plurality of small antennas.

In each of the circuits shown in FIGS. 3 and 4, the power receiving antenna is in common to the antenna for the radio waves used to transmit and receive signals in the operative sate of the appliance. However, separate dedicated antennas may be provided respectively for the radio waves frequently transferred in the environment including various appliances and the radio waves used to transmit and receive signals in the operative sate of the relevant appliance. Also, instead of preparing separate antennas having physically different arrangements adapted for respective wavelengths, a software configuration may be designed so as to provide a higher gain with the power receiving antenna in the standby state, and to provide a higher gain with the antenna for transmitting and receiving signals in the operative sate after the main power source switch SW1 has been turned on. Such a modification enables the power consumption to be suppressed while increasing the amount of power accumulated in the capacitor 3, and hence contributes to energy saving.

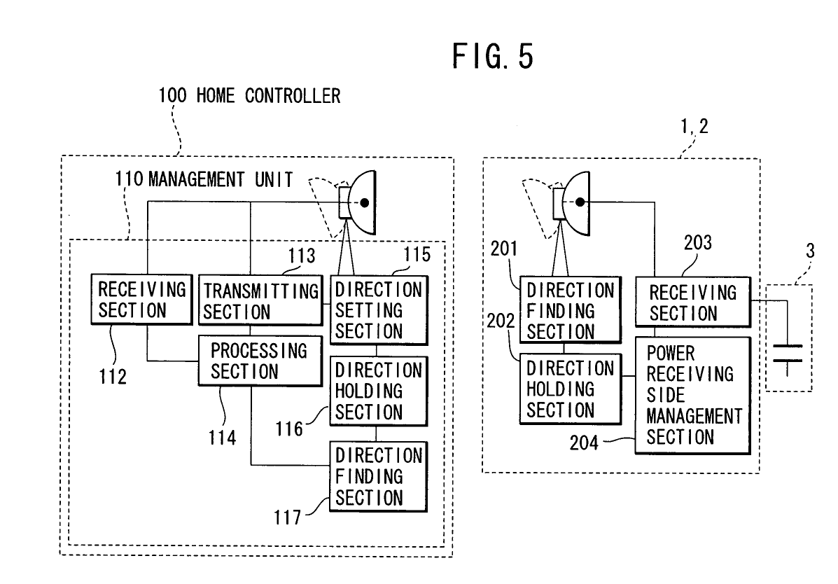

From the viewpoint of increasing the energy efficiency in power transmission, directivity is preferably given in radio communication. However, because the plurality of appliances on the power receiving side are positioned in different orientations with respect to the home controller on the power transmitting side, the power transmitting direction must be changed depending on the other side to be communicated with. FIG. 5 shows an antenna unit suitable for such directional radio communication.

There are two operation modes, i.e., a positioning mode and a normal mode. The positioning mode is to, when the electrical appliance 8 is added to a radio network of the home controller 100, to know the direction for transmitting and receiving the radio waves between them. The positioning mode is established, for example, by a method of instructing the start of the positioning mode from external switches on the electrical appliance 8 and the home controller 100 at the same time. A direction finding section 201 of the electrical appliance 8 divides all three-dimensional directions covering 360 degrees into N directions, orients the antenna in each of the directions from 1 through N in sequence at intervals of a certain time T, and repeats the orientation step N times. A direction finding section 117 of the home controller 100 orients the antenna in each of the directions from 1 through N in sequence at intervals of a certain time (T×N). Then, radio communication is performed between a transmitting section and a receiving section (indicated by 112 and 113) on both sides at intervals of the certain time T to find the direction in which the radio waves can be received with a maximum gain. Thus, because the electrical appliance 8 and the home controller 100 are oriented to face each other in any of (N×N) intervals of the certain time T, it is possible to find the direction in which the best communication state is obtained. By further dividing the direction in which the best communication state is obtained into N directions and repeating the above-described steps, an optimum three-dimensional direction can be found. N is set to a larger value when higher directivity is desired in the radio communication, and is set to a smaller value, e.g., 8, when the desired directivity is relatively low. In the positioning mode, both the sides may be connected to each other via a wire to make synchronization between them. After the optimum direction has been searched for, an end-of-search signal is transmitted and received, whereby a direction holding section 202 of the electrical appliance 8 holds the optimum direction and a direction holding section 116 of the home controller 100 holds the optimum direction in correspondence to the ID number of the electrical appliance 8. Although the home controller 100 can hold the optimum direction by actually receiving the radio waves via radio communication in the above-described manner, another manner is also usable. For example, a combination of the directions in which the radio waves received by the electrical appliance 8 provide an optimum value of the received power among the transmitting and receiving steps repeated (N×N) times may be informed to the home controller 100 along with the ID number of the electrical appliance 8 via radio communication, and the direction holding section 116 of the home controller 100 holds the optimum direction in correspondence to the ID number of the electrical appliance 8. The positioning mode is thereby completed, followed by shifting to the normal mode. In the normal mode, when the home controller 100 transmits power to the electrical appliance 8, a direction setting section 115 obtains, from the direction holding section 116, the optimum direction that is held in correspondence to the ID number of the electrical appliance 8 therein, and transmits the power in the optimum direction. When communicating signals in the operative state, the signals can also be similarly transmitted and received in the optimum direction if there is directivity.

The antenna is not limited to a parabolic antenna and may be constructed of an array comprising a plurality of small antennas as shown in FIG. 4. In the latter case, radio waves only in any desired direction can be received by, instead of rotating the antenna, employing a phased array antenna comprising a plurality of small antennas each provided with a phase shifter for arbitrarily changing the phase of radio waves, and then superimposing the received radio waves one above another while changing their phases.

FIG. 6 shows a processing flow of a communication procedure including power transmission at the start of communication between two electrical appliances 8 and the home controller 100. It is here assumed that the two electrical appliances 8 are a TV and a camera. The TV is in an operative state and is going to communicate with the camera, whereas the camera is in a standby state.

In step (1), the TV transmits a request along with the camera ID. Upon receiving the request, the home controller 100 checks the camera status stored therein. If the camera status is unidentified, the home controller 100 confirms the camera status in step (2). If a main power source for the camera is in a turned-on state at this time, an ACK is replied as in step (7). If no ACK is replied during a preset time-out period, the home controller 100 determines that the camera is in the standby state. Then, it sends a power transmission signal to the camera along with the camera ID in step (3), and informs the TV in step (4) of that the camera is in the standby state. Steps (3) and (4) may be reversed in sequence. Also, step (3) may be executed at the same time as step (2). In this case, however, when the camera is in an operative state at that time, the power transmitted in step (3) is wasted and energy saving is not achieved. By setting the time-out period, such wasteful consumption of power can be avoided. After receiving the power and confirming that the received ID is matched with its own ID, the camera transmits an ACK in step (5) to indicate that the camera is supplied with the power and is in an initialized state. The home controller 100 receives the ACK and relays it to the TV in step (6). When the initialization is completed, the camera transmits an ACK indicating the end of the initialization in step (7). The home controller 100 receives the ACK and relays it to the TV in step (8). Then, the home controller 100 transmits the request received in step (1) to the camera in step (9). In the illustrated example, to hold the TV in the standby state for a certain time, the ACK's are also transmitted to the TV side until step (9), but they may not be transmitted. In such a case, the TV side transmits the request several times as in step (1), and the home controller 100 relays the request to the camera after receiving the ACK in step (7). After step (9), communication is executed in a normal way until step (15). When the camera is brought into the standby state, it transmits an ACK indicating the status change in step (16). When the home controller 100 receives a signal indicating a status from each electrical appliance, it holds the received status along with the ID of the relevant electrical appliance. Thus, since there is no need of setting a time-out period after step (2) when the home controller 100 receives the request in step (1), the processing can be sped up.

If sufficient power is obtained from the power receiving unit 2, the electrical appliance can be started up with the power accumulated in the capacitor 3 without resorting to the main power source. For example, the electrical appliance can be operated in an application as follows. FIG. 7 illustrates an example in which the present invention is applied to a presentation system. When a PDA is put on a desk, the PDA can be supplied with power to start the operation. Since radio waves are not recognized by eyes, an illuminator is preferably turned on to indicate an area where the PDA is able to receive power.

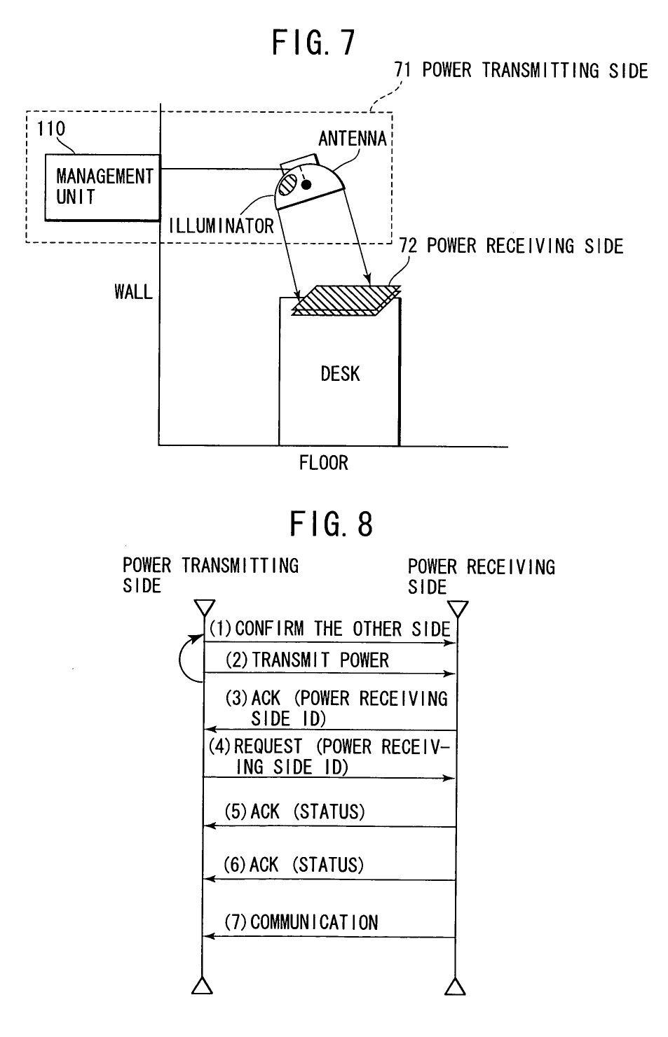

FIG. 8 shows a processing flow in the application example shown in FIG. 7. The transmitting side 71 repeats step (1) of transmitting a signal to confirm the other side and step (2) of transmitting power until the other side appears. The receiving side 72 replies an ACK in step (3). Until the ACK is replied in step (3), the power transmission in step (2) is intermittently performed to avoid wasteful consumption of power. As an alternative, more saving of power can be realized by setting a sensor on the desk and performing steps (1) and (2) only when the sensor detects something put on the desk. After step (3), the power transmission in step (2) and subsequent communication of signals are continued until an ACK is no longer replied or until it is confirmed by the sensor that there is nothing on the desk.

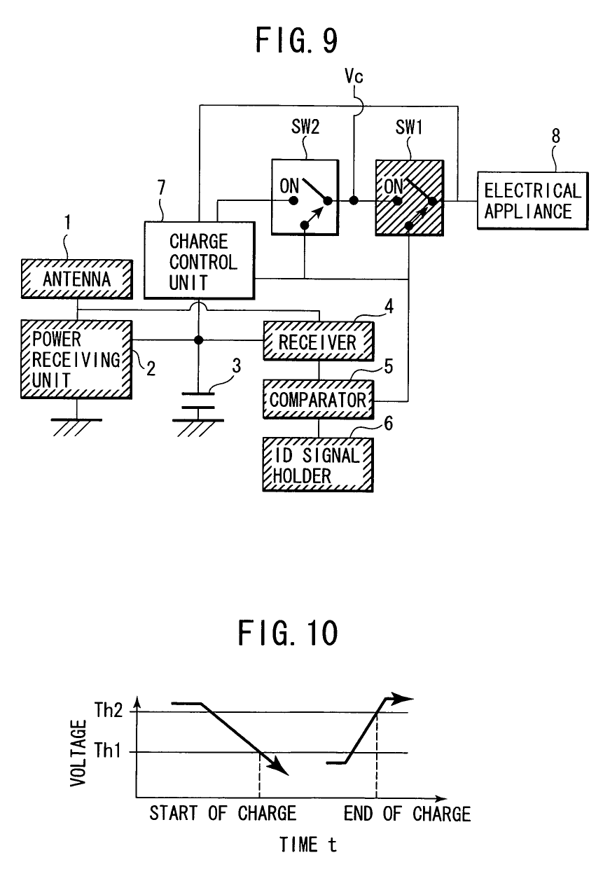

In some environment, the capacitor 3 cannot accumulate a sufficient amount of power because of, e.g., deficiency of the radio waves or poor performance of the power receiving unit 2. To cope with such a case, a charge control unit 7 is preferably provided to additionally charge power in the capacitor 3 when the main power source is turned on. FIG. 9 shows one example of a circuit adapted for that case. Components denoted by 1 (antenna) through 6 (ID signal holder), a main power source switch SW1, and an electrical appliance 8 function in the same manners as those shown in FIG. 1. The charge control unit 7 monitors the voltage across the capacitor 3, and when the monitored voltage is lower than Th1, it charges power in the capacitor 3 from the main power source Vc until the voltage across the capacitor 3 exceeds Th2. If the main power source switch SW1 is turned off, the power is supplied for charging from the main power source Vc by turning on another switch SW2.

FIG. 10 shows the relationship between the voltage across the capacitor 3 and the start and end of charge. By setting the relationship of Th1<Th2, the switch SW2 can be avoided from frequently repeating turning-on/off when the main source power is not supplied. As an alternative, another threshold Th1′ satisfying Th1<Th1′ may be set when the main source power is supplied.

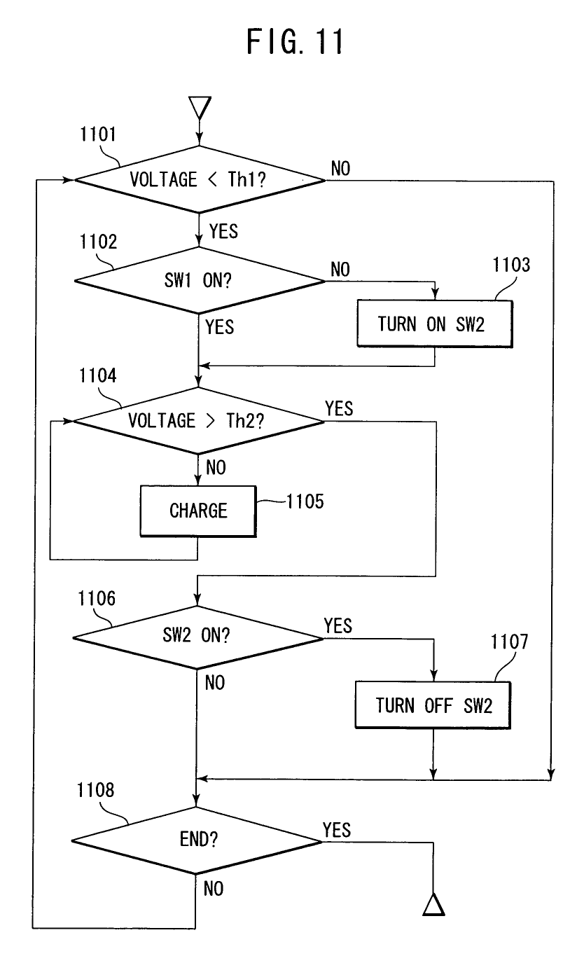

FIG. 11 shows an operation flow of the charge control unit 7. In step 1101, the charge control unit 7 monitors the voltage across the capacitor 3. If the monitored voltage is lower than Th1, it checks in step 1102 whether the main power source switch SW1 is turned on. If the switch SW1 is not turned on, another switch SW2 is turned on in step 1103. Then, power is charged in the capacitor 3 from the main power source Vc in steps 1104 and 1105 until the voltage across the capacitor 3 exceeds Th2. After the end of the charge, the charge control unit 7 checks in step 1106 whether the switch SW2 is turned on. If so, the switch SW2 is turned off in step 1107. If the end of the process is not instructed in step 1108, the processing flow returns to step 1101. The end of the process corresponds to the case of receiving a command from a switch indicating complete turning-off of the power source without shifting to the standby state. For example, when the cord of the electrical appliance 8 is withdrawn from a receptacle, the operation of the charge control unit 7 is brought to an end at once.

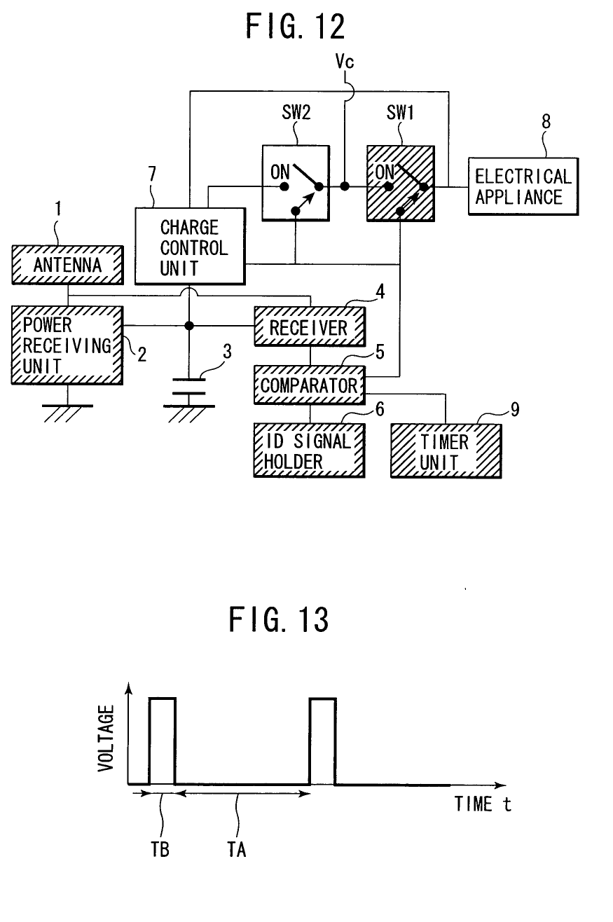

In the environment where the radio waves are frequently transferred, it is comparatively easy to accumulate a sufficient amount of power in the capacitor 3, while the power consumption is apt to increase because the receiver 4, the comparator 5, and the ID signal holder 6 are also frequently operated. One preferable method for suppressing the power consumed by the receiver 4, the comparator 5, and the ID signal holder 6, which are operated with the power accumulated in the capacitor 3, is to operate them in an intermittent manner. FIG. 12 shows one example of a circuit adapted for practicing that method. Components denoted by 1 (antenna) through 6 (ID signal holder), a main power source switch SW1, and an electrical appliance 8 function in the same manners as those shown in FIG. 1. A charge control unit 7 and another switch SW2 may also be provided as in the circuit of FIG. 9. In addition, a timer unit 9 operated with the power accumulated in the capacitor 3 is provided to operate the receiver 4, the comparator 5, and the ID signal holder 6 at intervals of a certain time. FIG. 13 shows the operation timing in the example of FIG. 12. By operating those components during a time period TB set by a timer B and not operating those components during a time period TA set by a timer A as shown, power can be cut in amount corresponding to (a×time periods set by the timer A) on an assumption that the voltage required for the operation is a. Here, the power consumed by the timer unit 9 must be smaller than the amount of power that can be cut.

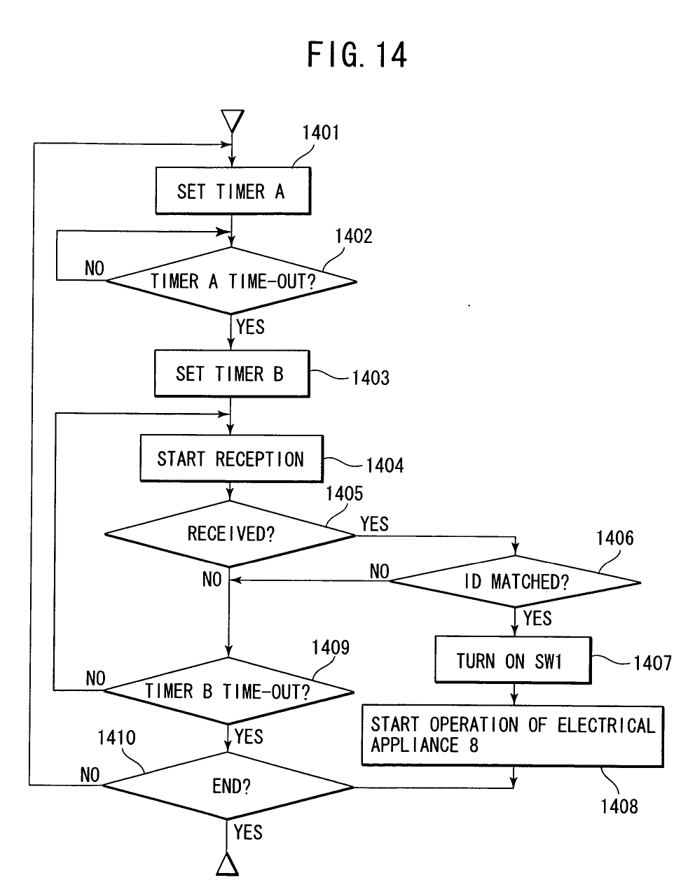

FIG. 14 shows an operation flow of the circuit including the timer unit 9. The timer unit 9 causes the timer A to set the time period TA in step 1401, and waits for time-out of the time period TA in step 1402. After the time-out of the time period TA set by the timer A, the timer unit 9 causes the timer B to set the time period TB in step 1403 and waits for time-out of the time period TB in step 1409. During the time period TB, the receiver 4, the comparator 5, and the ID signal holder 6 are operated. More specifically, the receiver 4 starts reception in step 1404. If any signal is received in step 1405, the comparator 5 takes out an ID from the received signal and compares the taken-out ID with the ID held in the ID signal holder 6 in step 1406. If both the ID's are matched with each other, the main power source switch SW1 is turned on in step 1407 to start the operation of the electrical appliance in step 1408. After the completion of the processing in step 1408, the process flow is brought to an end if it is commanded to make complete turning-off of the power source without shifting to the standby state. If not so, the process flow returns to step 1401 and comes into the standby state. Also, if no signal is received in step 1405, the process flow returns to step 1404 unless the time period TB set by the timer B is yet timed out in step 1409. If the time period TB is timed out, the process flow advances to step 1410. Alternatively, the processing from step 1403 through 1409 may be modified such that the process flow advances to step 1410 after checking whether the signal has been received M times, instead of setting the timer period by the timer.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An appliance control apparatus comprising:
an antenna for receiving radio waves;
a power receiving unit for taking out power from the radio waves received by said antenna;
a capacitor for accumulating the power taken out by said power receiving unit;
a signal receiving unit operated with the power accumulated in said capacitor and receiving a signal from the radio waves received by said antenna;
an ID signal holding for holding a signal indicative of an appliance ID;
a switch for selectively connecting an appliance and a power source; and
an ID signal comparing unit for receiving the signal from said signal receiving unit, comparing a target appliance ID contained in the received signal with the appliance ID read out from said ID signal holding unit when the received signal is a predetermined signal, and turning on said switch when both the ID's are matched with each other.

2. An appliance control apparatus according to claim 1, further comprising a charge control unit for charging power in said capacitor from said power source when the power accumulated in said capacitor is not sufficient.

3. An appliance control apparatus according to claim 1, further comprising a timer unit for controlling a time during which said signal receiving unit is operated.

4. An electrical appliance including an appliance control apparatus comprising:
an antenna for receiving radio waves;
a power receiving unit for taking out power from the radio waves received by said antenna;
a capacitor for accumulating the power taken out by said power receiving unit;
a signal receiving unit operated with the power accumulated in said capacitor and receiving a signal from the radio waves received by said antenna;
an ID signal holding for holding a signal indicative of an appliance ID;
a switch for selectively connecting an appliance and a power source; and
an ID signal comparing unit for receiving the signal from said signal receiving unit, comparing a target appliance ID contained in the received signal with the appliance ID read out from said ID signal holding unit when the received signal is a predetermined signal, and turning on said switch when both the ID's are matched with each other.

5. An appliance control apparatus according to claim 1, further comprising an amount-of-received power memory for dividing all directions capable of receiving power by said antenna into N directions, orienting said antenna in each of the N directions at intervals of a predetermined time to receive the power, and storing the direction and the amount of the received power in correspondence to each other; and
an antenna direction control unit for controlling the direction of said antenna in accordance with the amount of the received power stored in said amount-of-received power memory.

6. An appliance control apparatus comprising:
an antenna for transmitting and receiving radio waves;
an ID signal transmitting unit for transmitting, to an appliance, power and a signal containing an ID of said appliance via said antenna; and
a communication control unit for starting communication when said communication control unit receives, from an appliance designated by the appliance ID contained in the signal transmitted from said ID signal transmitting unit, a signal indicating that the designated appliance is in a state ready for reception.

7. An appliance control apparatus according to claim 6, further comprising a power transmitting unit for dividing all directions capable of receiving power by said antenna into N directions and transmitting power while orienting said antenna in each of the N directions at intervals of a predetermined time;
an amount-of-received power memory for storing the direction of said antenna oriented by said power transmitting unit and the amount of the received power in correspondence to each other;
a direction finding unit for obtaining, from a target appliance, an ID of said appliance and the direction in which the power has been received in maximum amount, after completion of the power transmission from said power transmitting unit;
a direction holding unit for storing the appliance ID and the direction in which the power has been received in maximum amount in correspondence to each other; and
a direction setting unit for obtaining the direction in correspondence to the appliance ID from said direction holding unit and setting said antenna to be oriented in the obtained direction.

8. An appliance control apparatus according to claim 7, wherein the power is transmitted at intervals of a time T1 until the reception ready signal is replied from the power receiving appliance, and at intervals of a time T2 (T1>T2) after the reception ready signal has been replied from the power receiving appliance.
